(19) United States
(12) Patent Application Publication
(10) Pub. No.: US 2016/0119532 A1
(43) Pub. Date: Apr. 28, 2016

(54) Method And Apparatus Of Utilizing Image/Video Data From Multiple Sources

(71) Applicant: MediaTek Inc., Hsinchu (TW)

(72) Inventors: Chiu-Ju Chen, Hsinchu (TW); Sheng-Hung Cheng, Hsinchu (TW)

(21) Appl. No.: 14/987,245

(22) Filed: Jan. 4, 2016

Related U.S. Application Data
(60) Provisional application No. 62/106,362, filed on Jan. 22, 2015.

(51) Int. Cl. H04N 5/232; G06T 7/00; H04N 5/265; H04N 13/02; H04N 5/225; H04N 5/45

(52) U.S. Cl. CPC H04N 5/23206; H04N 5/2258; H04N 5/23293; H04N 5/23216; H04N 5/45; H04N 5/265; H04N 13/0282; G06T 7/004

(57) ABSTRACT

A technique, as well as select implementations thereof, pertaining to utilizing video/audio data from multiple sources is described. One or more processors of a first apparatus may receive first data obtained at a first time of a first image sensor of the first apparatus. The first data may include image or video related data. The first apparatus may wirelessly receive from a second apparatus second data obtained at a second time by a second image sensor of the second apparatus. The second data may include image or video related data. A location or position of the second apparatus may be different from a location or position of the first apparatus. The first time may be equal to or different from the second time by no more than a predetermined time difference. The processor(s) of the first apparatus may perform a task using both the first data and the second data as input.

### CROSS REFERENCE TO RELATED PATENT APPLICATION

The present disclosure claims the priority benefit of U.S. Provisional Patent Application No. 62/106,362, filed on 22 Jan. 2015, which is incorporated by reference in its entirety.

### TECHNICAL FIELD

The present disclosure is generally related to wirelessly receiving data from multiple sources and, more particularly, to utilizing image/video/audio data received from multiple sources.

### BACKGROUND

Unless otherwise indicated herein, approaches described in this section are not prior art to the claims listed below and are not admitted to be prior art by inclusion in this section.

At present time, applications using multiple cameras such as, for example, picture-in-picture (PIP) and stereo features (e.g., three-dimensional (3D) capture, fast autofocus, image refocus and distance measurement) are based on a premise that an apparatus on which the application is executed has at least two image sensors/cameras. Accordingly, implementations of such applications tend to be constrained by hardware. However, the hardware cost tends to be higher when the apparatus is configured or otherwise equipped to support multi-camera features and applications.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve receiving, by a first apparatus, first data obtained at a first time by a first image sensor of the first apparatus. The first data may include at least image or video related data. The method may also involve wirelessly receiving, by the first apparatus from a second apparatus, second data obtained at a second time by a second image sensor of the second apparatus. The second data may include at least image or video related data. A location or position of the second apparatus may be different from a location or position of the first apparatus. The first time may be equal to or different from the second time by no more than a predetermined time difference. The method may further involve performing, by one or more processors of the first apparatus, a task using both the first data and the second data as input.

In another example implementation, a method may involve receiving, by a first apparatus, first data obtained at a first time by a first image sensor of the first apparatus. The first data may include at least image or video related data. The method may also involve wirelessly receiving, by the first apparatus from a second apparatus, second data obtained at a second time by a second image sensor of the second apparatus. The second data may include at least image or video related data. A location or position of the second apparatus may be different from a location or position of the first apparatus. The first time may be equal to or different from the second time by no more than a predetermined time difference. The method may further involve determining, by either or both of the first apparatus and the second apparatus, whether either or both of the first data and the second data satisfies one or more criteria. The method may additionally involve performing, by either or both of the first apparatus and the second apparatus, one or more remedial actions in response to a determination that at least one of the first data and the second data does not satisfy the one or more criteria.

In yet another example implementation, a first apparatus may include a first image sensor, a memory and one or more processors. The memory may be configured to store at least data or one or more sets of instructions therein. The processor(s) may be coupled to access the data or the one or more sets of instructions stored in the memory. The processor(s) may be configured to receive second data obtained at a second time by a second image sensor of a second apparatus. The second data may be transmitted wirelessly by the second apparatus. The processor(s) may be also configured to receive first data obtained at a first time by the first image sensor. The processor(s) may be further configured to perform a task using at least the second data and the first data as input. The first data may include at least image or video related data. The second data may include at least image or video related data. A location or position at which the second data may be obtained is different from a location or position at which the first data is obtained. The first time may be equal to or different from the second time by no more than a predetermined time difference.

Accordingly, implementations in accordance with the present disclosure address the issue of hardware limitation and higher hardware cost associated with support for multi-camera applications. Advantageously, an apparatus in accordance with the present disclosure may receive and utilize image/video/audio data captured, taken or otherwise obtained by image sensor(s)/camera(s) of one or more other apparatuses.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example scenario in accordance with another implementation of the present disclosure.

FIG. 3 is a diagram of an example feature in accordance with an implementation of the present disclosure.

FIG. 4 is a diagram of an example feature in accordance with another implementation of the present disclosure.

FIG. 5 is a diagram of an example feature in accordance with yet another implementation of the present disclosure.

FIG. 6 is a diagram of an example feature in accordance with still another implementation of the present disclosure.

FIG. 7 is a block diagram of an example apparatus in accordance with an implementations of the present disclosure.

FIG. 8 is a flowchart of an example process in accordance with an implementation of the present disclosure.

FIG. 9 is a flowchart of an example process in accordance with another implementation of the present disclosure.

### DETAILED DESCRIPTION OF PREFERRED EMBODIMENTS

### Overview

Implementations in accordance with the present disclosure enable an apparatus to receive and utilize image data, video data and/or audio data (interchangeably referred to as “image/video/audio data” herein) captured, taken or otherwise obtained by image sensor(s)/camera(s) of one or more other apparatuses. Thus, by employing image sensor(s) and/or camera(s) of one or more other apparatuses, the apparatus may benefit from multi-camera features and/or applications beyond the physical limitation in terms of hardware (e.g., one image sensor/camera) with which the apparatus is equipped. The apparatus may establish wireless communication with one or more other apparatuses and receive image/video/audio data from each of the one or more other apparatuses, and the apparatus may perform, render, provide, effect or otherwise realize multi-camera features and/or applications by combining or otherwise utilizing both image/video/audio data obtained by itself and the image/video/audio data received from each of the one or more other apparatuses. The image/video/audio data may be captured, taken or otherwise obtained by image sensor(s)/camera(s) of the apparatus simultaneous with, concurrent with, or within a time difference from the one or more other apparatuses. Accordingly, not only contents but also software and/or hardware resources of the apparatus and the one or more other apparatuses can be shared and/or further manipulated, enabling the apparatus and the one or more other apparatuses to operate like a single apparatus that is more powerful than the apparatus standalone without a cloud server.

It is noteworthy that techniques in accordance with the present disclosure, while applicable to and implementable in scenarios in which one apparatus (interchangeably referred to as a “sink” herein) may receive image/video/audio data from one other apparatus (interchangeably referred to as a “source” herein), may be also applicable to and implementable in scenarios in which one sink receives image/video/audio data from multiple sources, scenarios in which multiple sinks receive image/video/audio data from one source, and scenarios in which multiple sinks receive image/video/audio data from multiple sources. For simplicity and ease of understanding of techniques in accordance with the present disclosure, examples provided herein are provided in the context of one source and one sink, although the techniques illustrated in the examples are also applicable to and implementable in contexts in which there are multiple sinks and/or multiple sources.

Additionally, in various implementations in accordance with the present disclosure, each sink may wirelessly receive image/video/audio data from each source for real-time communication. The image/video/audio data obtained by a source may be transmitted to a sink at any processing stage of the source. Each sink may wirelessly receive image/video/audio data directly from each source. Alternatively or additionally, each sink may wirelessly receive image/video/audio data indirectly from each source (e.g., via an access point, a relay or another device). For instance, in one topology, a sink and a sink may be wirelessly connected to one another directly. In another topology, a sink and a sink may be wirelessly connected to one another indirectly via an access point, a relay or another device. In yet another topology, a sink and a sink may be wirelessly connected to one another both directly and indirectly via an access point, a relay or another device. For simplicity and ease of understanding of techniques in accordance with the present disclosure, examples provided herein are illustrated in the context of the topology in which a sink and a source are wirelessly connected to one another directly, although the techniques illustrated in the examples are also applicable to and implementable in contexts of other topologies.

Furthermore, in accordance with the present disclosure, calibration of a sink, a source, or both the sink and the source may be made. For instance, the sink may generate indication(s) for adjusting the position and/or angle of the source and/or the sink. Additively or alternatively, the source may generate indication(s) for adjusting the position and/or angle of the sink and/or the source. The sink/source may do so by comparing and/or mapping image/video data obtained by the sink and the image/video data obtained by the source. In one embodiment, feature points of respective image/video data obtained by the sink and the source can be compared to generate the indication(s). The indication(s) may be shown or realized in various forms such as, for example and not limited to, message(s) and/or visual/audible indication(s) on a user interface of the sink and/or the source. The indication(s) may inform a user of the sink and/or a user of the source of how to adjust the position and/or angle and/or setting(s) and/or configuration(s) of the sink and/or source. In some implementations, a suitable image or video may be automatically retrieved from a series of images or videos obtained by the sink or the source to replace a given image or video obtained by the sink or the source.

It is also noteworthy that, although examples provided herein may pertain to image/video data, implementations in accordance with the present disclosure may also apply to audio data.

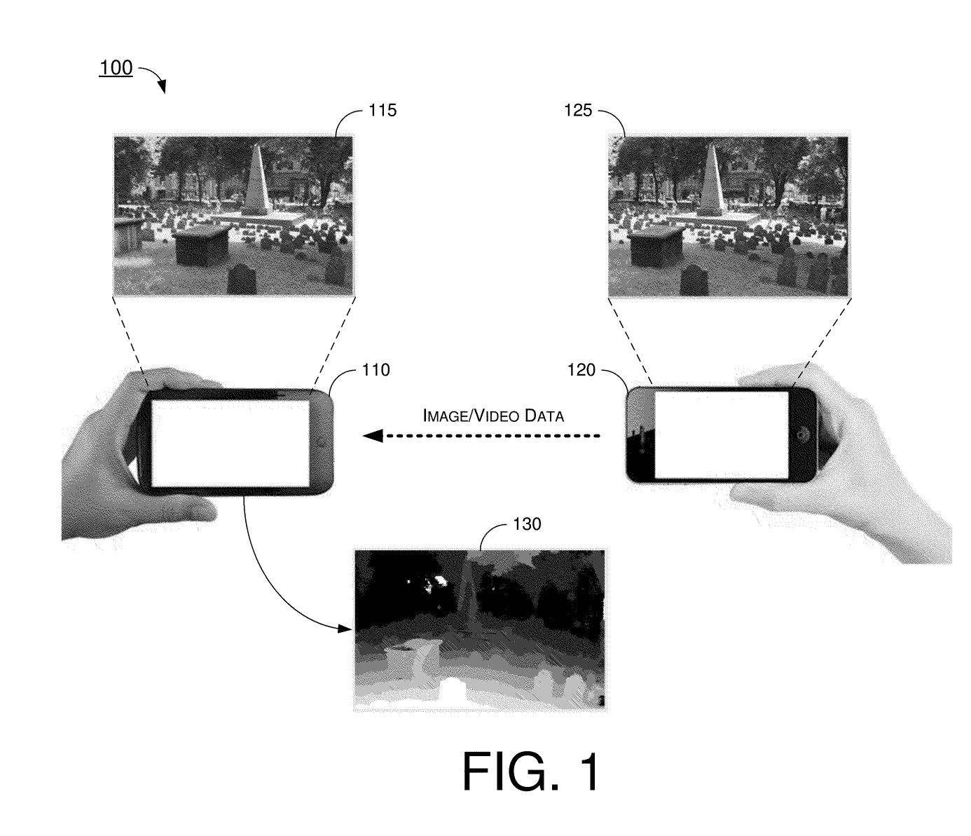

FIG. 1 illustrates an example scenario 100 in accordance with an implementation of the present disclosure. In scenario 100, an apparatus 110 may be the sink and another apparatus, apparatus 120, may be the source in that image/video/audio data captured, taken or otherwise obtained by apparatus 120, the source, is wirelessly transmitted to and received by apparatus 110, the sink. Each of apparatus 110 and apparatus 120 may be a portable electronic apparatus such as, for example, a smartphone, a wearable device or a computing device such as a tablet computer, a laptop computer, a notebook computer. In the example shown in FIG. 1, each of apparatus 110 and apparatus 120 may be a smartphone and each may be equipped with a rear image sensor or camera, respectively, capable of capturing, taking or otherwise obtaining two-dimensional (2D) still images and videos. That is, each of apparatus 110 and apparatus 120 may be equipped with an image sensor or camera that is on the rear side of the apparatus whereas the front side of the apparatus includes a user interface device (e.g., a touch sensing display) that normally faces a user thereof.

In scenario 100, each of apparatus 110 and apparatus 120 may respectively capture, take or otherwise obtain a 2D image of a scene using its respective image sensor/camera. Apparatus 110 may obtain a 2D image 115 of the scene at a first orientation while apparatus 120 may obtain a 2D image 125 of the scene at a second orientation that is different from the first orientation. For instance, image 115 and image 125 may be obtained at different angles, pitches, rolls, yaws and/or positions with respect to one another. Apparatus 120 may wirelessly transmit data representative of image 125 to apparatus 110. After receiving the data representative of image 125 from apparatus 120, apparatus 110 may utilize both image 115 and image 125 to generate one or more stereo features such as, for example and not limited to, a three-dimensional (3D) visual effect. The 3D visual effect may include, for example and not limited to, a depth image and/or a 3D capture. Alternatively or additionally, the one or more stereo features may include, for example and not limited to, autofocus, image refocus and/or distance measurement. In the example shown in FIG. 1, apparatus 110 may generate a depth map 130 of the scene based on both image 115 and image 125. Advantageously, although apparatus 110 is equipped with one image sensor/camera, apparatus 110 is able to perform, render, provide, effect or otherwise realize multi-camera features and/or applications by combining or otherwise utilizing image 115 obtained by itself and image 125 received from apparatus 120.

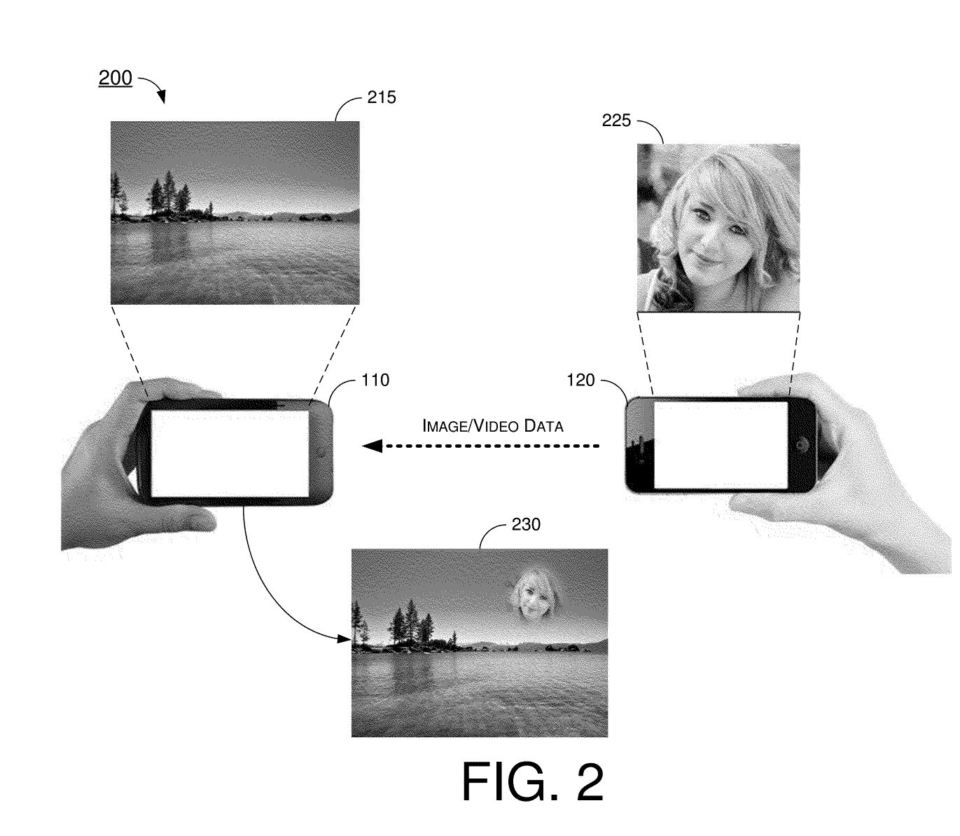

FIG. 2 illustrates an example scenario 200 in accordance with another implementation of the present disclosure. In scenario 200, similar to scenario 100, apparatus 110 may be the sink and apparatus 120 may be the source in that image/video/audio data captured, taken or otherwise obtained by apparatus 120, the source, is wirelessly transmitted to and received by apparatus 110, the sink.

In scenario 200, apparatus 110 may capture, take or otherwise obtain a 2D image 215 of a scene using its image sensor/camera while apparatus 120 may capture, take or otherwise obtain a 2D image 225 of a scene, person or object using its image sensor/camera. Apparatus 120 may wirelessly transmit data representative of image 225 to apparatus 110. After receiving the data representative of image 225 from apparatus 120, apparatus 110 may utilize both image 215 and image 225 to render a picture-in-picture effect. In the example shown in FIG. 2, apparatus 110 may generate a picture-in-picture effect 230 based on image 215 of a scene and image 225 of a person. Advantageously, although apparatus 110 is equipped with one image sensor/camera, apparatus 110 is able to perform, render, provide, effect or otherwise realize multi-camera features and/or applications by combining or otherwise utilizing image 215 obtained by itself and image 225 received from apparatus 120.

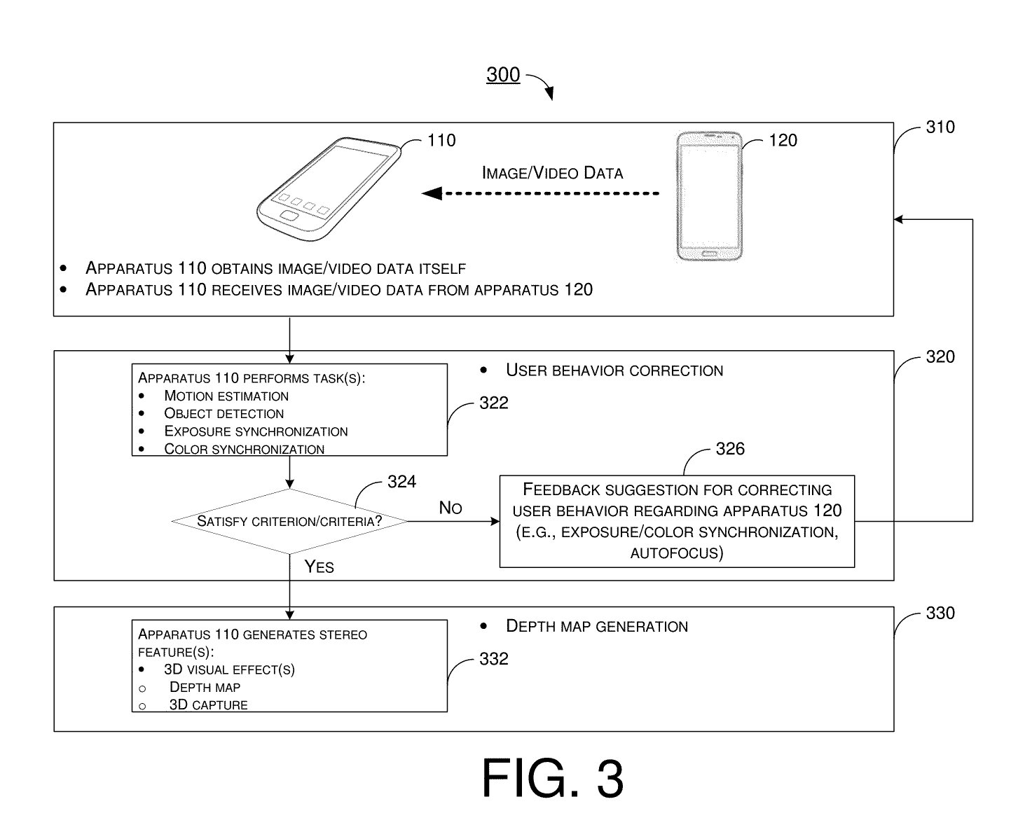

FIG. 3 illustrates an example feature 300 in accordance with an implementation of the present disclosure. In the example shown in FIG. 3, apparatus 110 may be the sink and apparatus 120 may be the source in that image/video/audio data captured, taken or otherwise obtained by apparatus 120, the source, is wirelessly transmitted to and received by apparatus 110, the sink. Feature 300 may involve one or more operations, actions, or functions as represented by one or more of blocks 310, 320 and 330. Although illustrated as discrete blocks, various blocks of feature 300 may be divided into additional blocks, combined into fewer blocks, or eliminated, depending on the desired implementation. Although the embodiment described herein is explained by a condition or time that apparatus 110 is the sink and apparatus 120 is the source, in the same embodiment or other different embodiments, apparatus 110 may be the source and apparatus 120 may be the sink.

At 310, apparatus 110 may obtain image/video data (e.g., a 2D image) using its image sensor/camera, apparatus 120 may also obtain image/video data (e.g., a 2D image) using its image sensor/camera, and the image/video data obtained by apparatus 120 may be wirelessly transmitted to and received by apparatus 110. Feature 300 may proceed from 310 to 320.

At 320, apparatus 110 may perform one or more tasks utilizing the image/video data obtained by apparatus 110 as well as the image/video data obtained by apparatus 120, and may cause or otherwise result in user behavior correction. Block 320 may include a number of sub-blocks such as 322, 324 and 326.

At 322, apparatus 110 may perform one or more tasks based on the image/video data obtained by apparatus 110 and the image/video data obtained by apparatus 120. Such task(s) may include, for example and not limited to, motion estimation, object detection, exposure synchronization and/or color synchronization. Feature 300 may proceed from 322 to 324. At 324, apparatus 110 may determine whether the image/video data obtained by apparatus 110 (e.g., image/frame 115 or image 215) and/or the image/video data obtained by apparatus 120 (e.g., image/frame 125 or image/frame 225) satisfies one or more predefined criteria. The one or more predefined criteria may be utilized to judge whether the image/frame 125 and the image/frame 225 or information thereof are suitable for generating a 3D image. In an event that it is determined that the one or more criteria is/are satisfied, feature 300 may proceed from 324 to 330. In an even that it is determined that the one or more criteria is/are not satisfied, feature 300 may proceed from 324 to 326. At 326, apparatus 110 may provide an indication to a user to request an input for the adjusting of the one or more parameters associated with either or both of the image/video data obtained by apparatus 110 and the image/video data obtained by apparatus 120. For instance, apparatus 110 may provide feedback suggestion 326 for correcting user behavior regarding apparatus 120 such as, for example, exposure synchronization, color synchronization and/or autofocus. The feedback may be used to cause apparatus 120 to adjust its setting or configuration, and/or cause indication(s) to appear on a user interface of apparatus 120 to inform a user of apparatus 120 of how to adjust the position/angle/setting(s)/configuration(s) of apparatus. Feature 300 may proceed from 326 to 310 for user of apparatus 120 to obtain new image/video data in accordance with the feedback.

At 330, apparatus 110 may generate one or more stereo features utilizing the image/video data obtained by apparatus 110 (e.g., image/frame 115 or image/frame 215) and/or the image/video data obtained by apparatus 120 (e.g., image/frame 125 or image/frame 225) by generating 3D visual effect(s) such as a depth map (e.g., depth map 130) and/or 3D capture.

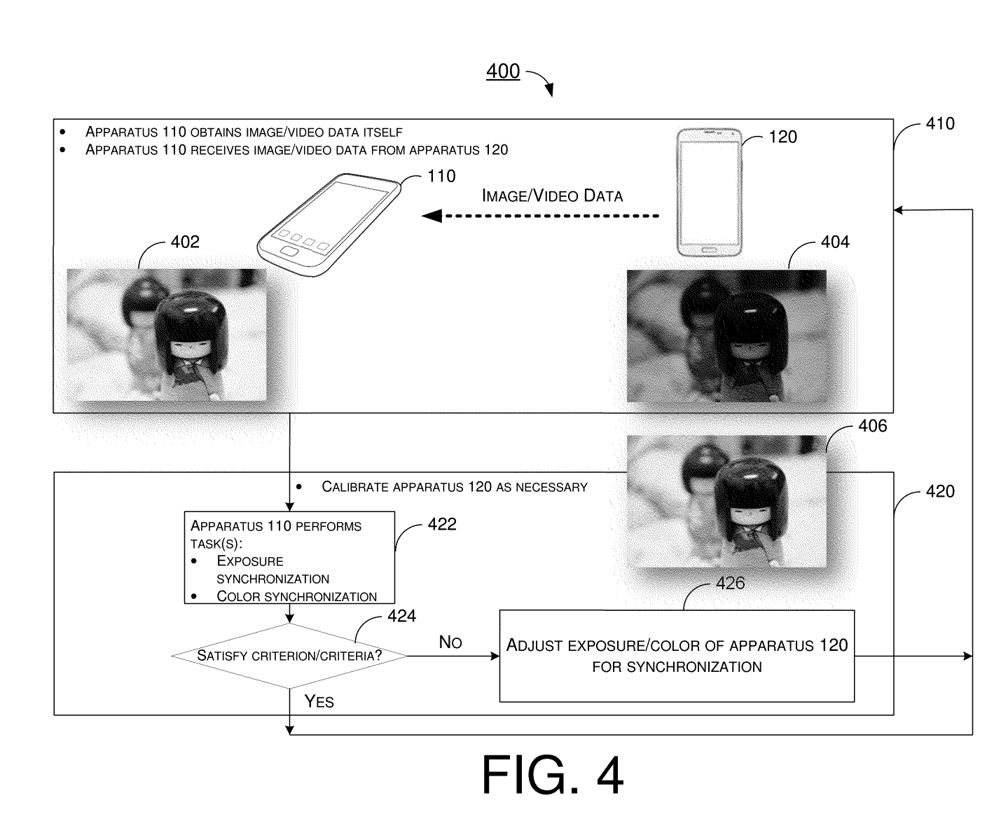

FIG. 4 illustrates an example feature 400 in accordance with another implementation of the present disclosure. In the example shown in FIG. 4, apparatus 110 may be the sink and apparatus 120 may be the source in that image/video/audio data captured, taken or otherwise obtained by apparatus 120, the source, is wirelessly transmitted to and received by apparatus 110, the sink. Feature 400 may involve one or more operations, actions, or functions as represented by one or more of blocks 410 and 420. Although illustrated as discrete blocks, various blocks of feature 400 may be divided into additional blocks, combined into fewer blocks, or eliminated, depending on the desired implementation. Although the embodiment described herein is explained by a condition or time that apparatus 110 is the sink and apparatus 120 is the source, in the same embodiment or other different embodiments, apparatus 110 may be the source and apparatus 120 may be the sink.

At 410, apparatus 110 may obtain image/video data (e.g., a 2D image) using its image sensor/camera, apparatus 120 may also obtain image/video data (e.g., a 2D image) using its image sensor/camera, and the image/video data obtained by apparatus 120 may be wirelessly transmitted to and received by apparatus 110. Feature 400 may proceed from 410 to 420. In the example shown in FIG. 4, apparatus 110 may obtain a first image 402 of an object, and apparatus 120 may obtain a second image/frame 404 of the same object. The exposure and/or color of image 402 may be different from the exposure and/or color of image 404.

At 420, apparatus 110 may perform one or more tasks utilizing the image/video data obtained by apparatus 110 (e.g., first image/frame 402) as well as the image/video data obtained by apparatus 120 (e.g., second image/frame 404), and may cause or otherwise result in calibration of apparatus 120 and/or apparatus 110. Block 420 may include a number of sub-blocks such as 422, 424 and 426.

At 422, apparatus 110 may perform one or more tasks based on the image/video data obtained by apparatus 110 and the image/video data obtained by apparatus 120. Such task(s) may include, for example and not limited to, exposure synchronization and color synchronization. Feature 400 may proceed from 422 to 424. At 424, apparatus 110 may determine whether the image/video data obtained by apparatus 110 (e.g., image 115 or image 215) and/or the image/video data obtained by apparatus 120 (e.g., image 125 or image 225) satisfies one or more predefined criteria. For instance, apparatus 110 may calculate, compute or otherwise determine the exposure and/or color of the image/video data obtained by each of apparatus 110 and apparatus 120 (e.g., image 402 and image 404) to determine whether a difference between the exposure and/or color between first image/frame 402 and second image/frame 404 is greater than a predefined threshold. In the same instance or other instances, apparatus 110 may calculate, compute or otherwise determine whether first image/frame 402 and second image/frame 404 or information thereof are suitable for generating a 3D image. In an event that it is determined that the one or more criteria is/are satisfied (e.g., the difference between the exposure and/or color between first image/frame 402 and second image/frame 404 is not greater than the predefined threshold), feature 400 may proceed from 424 to 410 for subsequently obtained image/video data. In an even that it is determined that the one or more criteria is/are not satisfied (e.g., the difference between the exposure and/or color between first image/frame 402 and second image/frame 404 is greater than the predefined threshold), feature 400 may proceed from 424 to 426. At 426, apparatus 110 may calibrate the exposure and/or color of the image sensor/camera of apparatus 120 by, for example, generating and transmitting data and/or command(s) to apparatus 120 to adjust the exposure and/or white balance of the image sensor/camera of apparatus 120 so as to achieve synchronization. The feedback may be used to cause apparatus 120 to adjust its setting or configuration, and/or cause indication(s) to appear on a user interface of apparatus 120 to inform a user of apparatus 120 of how to adjust the position/angle/setting(s)/configuration(s) of apparatus. Accordingly, apparatus 120 may obtain a third image 406 with synchronized exposure and/or color with respect to first image/frame 402. For exposure, a deviation of the statistical average value of the exposure of apparatus 110 and/or apparatus 120 may need to be less than a predefined threshold. For white balance, a deviation of the statistical average of RGB value of apparatus 110 and/or apparatus 120 may need to be less than a predefined threshold. Feature 400 may proceed from 426 to 410 for subsequently obtained image/video data.

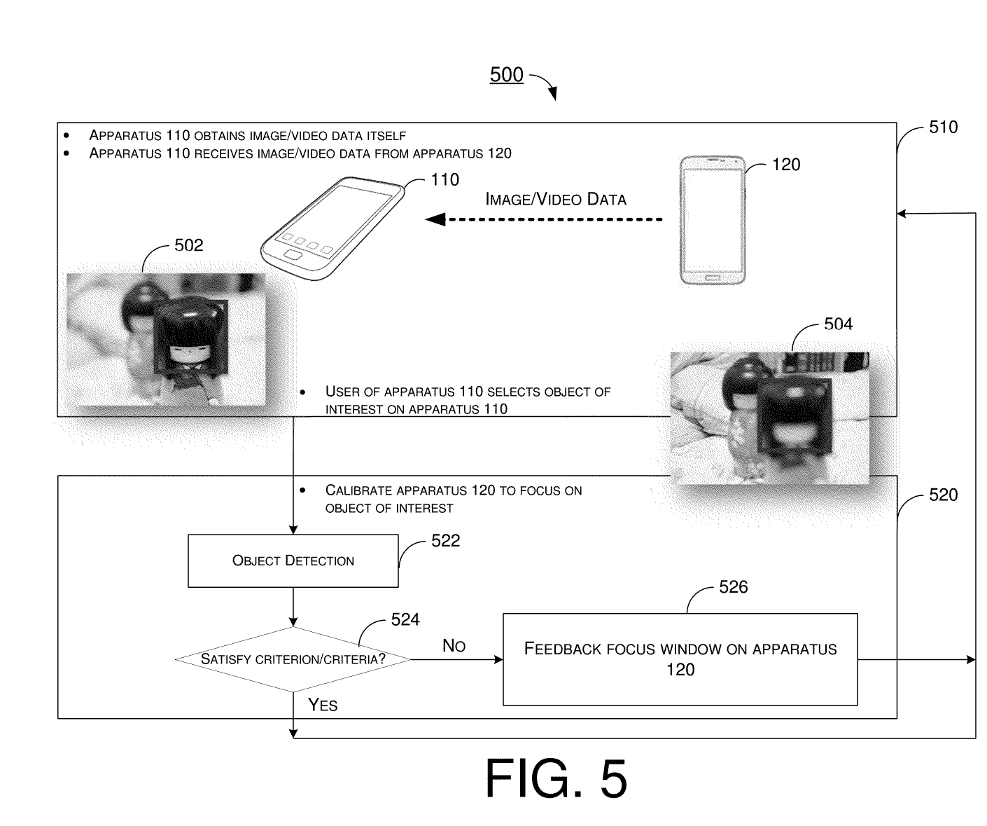

FIG. 5 illustrates an example feature 500 in accordance with yet another implementation of the present disclosure. In the example shown in FIG. 5, apparatus 110 may be the sink and apparatus 120 may be the source in that image/video/audio data captured, taken or otherwise obtained by apparatus 120, the source, is wirelessly transmitted to and received by apparatus 110, the sink. Feature 500 may involve one or more operations, actions, or functions as represented by one or more of blocks 510 and 520. Although illustrated as discrete blocks, various blocks of feature 500 may be divided into additional blocks, combined into fewer blocks, or eliminated, depending on the desired implementation. Although the embodiment described herein is explained by a condition or time that apparatus 110 is the sink and apparatus 120 is the source, in the same embodiment or other different embodiments, apparatus 110 may be the source and apparatus 120 may be the sink.

At 510, apparatus 110 may obtain image/video data (e.g., a 2D image) using its image sensor/camera, apparatus 120 may also obtain image/video data (e.g., a 2D image) using its image sensor/camera, and the image/video data obtained by apparatus 120 may be wirelessly transmitted to and received by apparatus 110. Feature 500 may proceed from 510 to 520. In the example shown in FIG. 5, apparatus 110 may obtain a first image/frame 502, and apparatus 120 may obtain a second image/frame 504. Apparatus 110 may also receive a user input that selects an object of interest in first image/frame 502.

At 520, apparatus 110 may perform one or more tasks utilizing the image/video data obtained by apparatus 110 (e.g., first image/frame 502) as well as the image/video data obtained by apparatus 120 (e.g., second image/frame 504), and may cause or otherwise result in calibration of apparatus 120 to focus an object of interest in second image/frame 504. Block 520 may include a number of sub-blocks such as 522, 524 and 526.

At 522, apparatus 110 may detect the object of interest in first image/frame 502 to form a focus window in first image/frame 502 and may transmit data/command(s) to apparatus 120 to cause apparatus 120 to detect the object of interest in second image/frame 504 to form a focus window in second image/frame 504. Feature 500 may proceed from 522 to 524. At 524, apparatus 110 may determine whether the image/video data obtained by apparatus 110 (e.g., image 115 or image 215) and/or the image/video data obtained by apparatus 120 (e.g., image 125 or image 225) satisfies one or more predefined criteria. For instance, apparatus 110 may calculate, compute or otherwise determine whether a difference between a size of the object of interest in the focus window in first image/frame 502 and a size of the object of interest in the focus window in second image/frame 504 is greater than a predefined threshold. In the same instance or other instances, apparatus 110 may calculate, compute or otherwise determine whether first image/frame 502 and second image/frame 504 or information thereof are suitable for generating a 3D image. In an event that it is determined that the one or more criteria is/are satisfied (e.g., the difference is not greater than the predefined threshold or first image/frame 502 and second image/frame 504 are not suitable for generating a 3D image), feature 500 may proceed from 524 to 510 for subsequently obtained image/video data. In an even that it is determined that the one or more criteria is/are not satisfied (e.g., the difference is greater than the predefined threshold), feature 500 may proceed from 524 to 526. At 526, apparatus 110 may calibrate the focus of the image sensor/camera of apparatus 120 by, for example, generating and transmitting data and/or command(s) as feedback to apparatus 120 to adjust the focus of the image sensor/camera of apparatus 120 to obtain a clear image of the object of interest in the focus window. The feedback may be used to cause apparatus 120 to adjust its setting or configuration, and/or cause indications to appear on a user interface of apparatus 120 to inform a user of apparatus 120 of how to adjust the position/angle/setting(s)/configuration(s) of apparatus. Feature 500 may proceed from 526 to 510 for subsequently obtained image/video data.

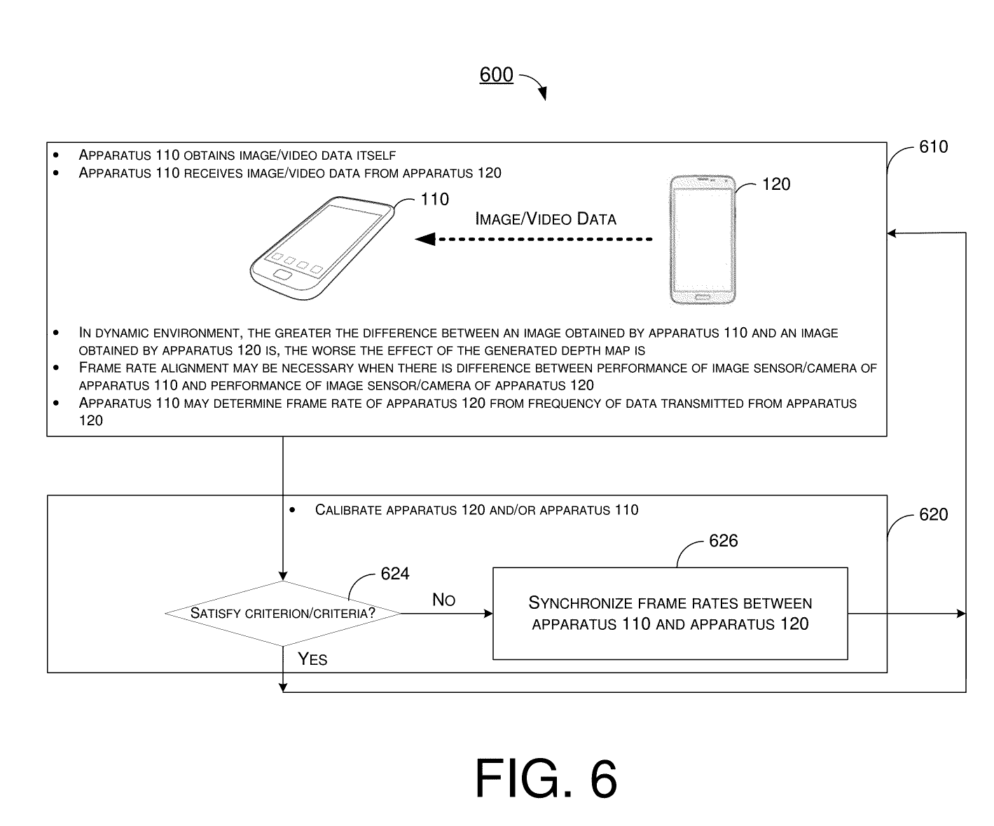

FIG. 6 illustrates an example feature 600 in accordance with still another implementation of the present disclosure. In the example shown in FIG. 6, apparatus 110 may be the sink and apparatus 120 may be the source in that image/video/audio data captured, taken or otherwise obtained by apparatus 120, the source, is wirelessly transmitted to and received by apparatus 110, the sink. Feature 600 may involve one or more operations, actions, or functions as represented by one or more of blocks 610 and 620. Although illustrated as discrete blocks, various blocks of feature 600 may be divided into additional blocks, combined into fewer blocks, or eliminated, depending on the desired implementation. Although the embodiment described herein is explained by a condition or time that apparatus 110 is the sink and apparatus 120 is the source, in the same embodiment or other different embodiments, apparatus 110 may be the source and apparatus 120 may be the sink.

At 610, apparatus 110 may obtain image/video data (e.g., a 2D image) using its image sensor/camera, apparatus 120 may also obtain image/video data (e.g., a 2D image) using its image sensor/camera, and the image/video data obtained by apparatus 120 may be wirelessly transmitted to and received by apparatus 110. Feature 600 may proceed from 610 to 620. In a dynamic environment, the greater a difference between the image/video data obtained by the image sensor/camera of apparatus 110 and the image/video data obtained by the image sensor/camera of apparatus 120 is, the worse an effect of a generated depth map may be. For instance, when there is difference between the performance or capability of the image sensor/camera of apparatus 110 and the performance or capability of the image sensor/camera of apparatus 120, frame rate alignment may be necessary. Apparatus 110 may determine the frame rate of the image sensor/camera of apparatus 120 based at least in part on the frequency of the data transmitted from apparatus 120.

At 620, apparatus 110 may perform one or more tasks utilizing the image/video data obtained by apparatus 110 (e.g., first image/frame 602) as well as the image/video data obtained by apparatus 120 (e.g., second image/frame 604), and may cause or otherwise result in calibration of apparatus 110 and/or apparatus120 to synchronize the frame rates of apparatus 110 and apparatus 120. Block 620 may include a number of sub-blocks such as 624 and 626.

At 624, apparatus 110 may determine whether the image/video data obtained by apparatus 110 (e.g., image 115 or image 215) and/or the image/video data obtained by apparatus 120 (e.g., image 125 or image 225) satisfies one or more predefined criteria. For instance, apparatus 110 may calculate, compute or otherwise determine whether a difference between the frame rate of apparatus 120 and the frame rate of apparatus 110 is less than a predefined threshold (e.g., duration of a frame). In the same instance or other instances, apparatus 110 may calculate, compute or otherwise determine whether first image/frame 602 and second image/frame 604 or information thereof are suitable for generating a 3D image. In an event that it is determined that the one or more criteria is/are satisfied (e.g., the difference is not greater than the predefined threshold), feature 600 may proceed from 624 to 610 for subsequently obtained image/video data. In an even that it is determined that the one or more criteria is/are not satisfied (e.g., the difference is greater than the predefined threshold), feature 600 may proceed from 624 to 626. At 626, apparatus 110 may synchronize the frame rate of apparatus 110 and the frame rate of apparatus 120 by, for example, adjusting the frame rate of 110 and/or generating and transmitting data and/or command(s) as feedback to apparatus 120 to adjust the frame rate of apparatus 120 to achieve frame rate synchronization. For example, when the frame rate of apparatus 110 is 30 frames per second (fps) and the frame rate of apparatus 120 is 24 fps, apparatus 110 may decrease the frame rate of apparatus 110 from 30 fps to 24 fps via frame rate range. As another example, when the frame rate of apparatus 110 is 24 fps and the frame rate of apparatus 120 is 30 fps, apparatus 110 may feedback frame rate range to apparatus 120 to cause apparatus 120 to decrease the frame rate of apparatus 120 from 30 fps to 24 fps. The feedback may be used to cause apparatus 120 to adjust its setting or configuration, and/or cause indication(s) to appear on a user interface of apparatus 120 to inform a user of apparatus 120 of how to adjust the position/angle/setting(s)/configuration(s) of apparatus. Feature 500 may proceed from 526 to 510 for subsequently obtained image/video data.

### Example Implementations

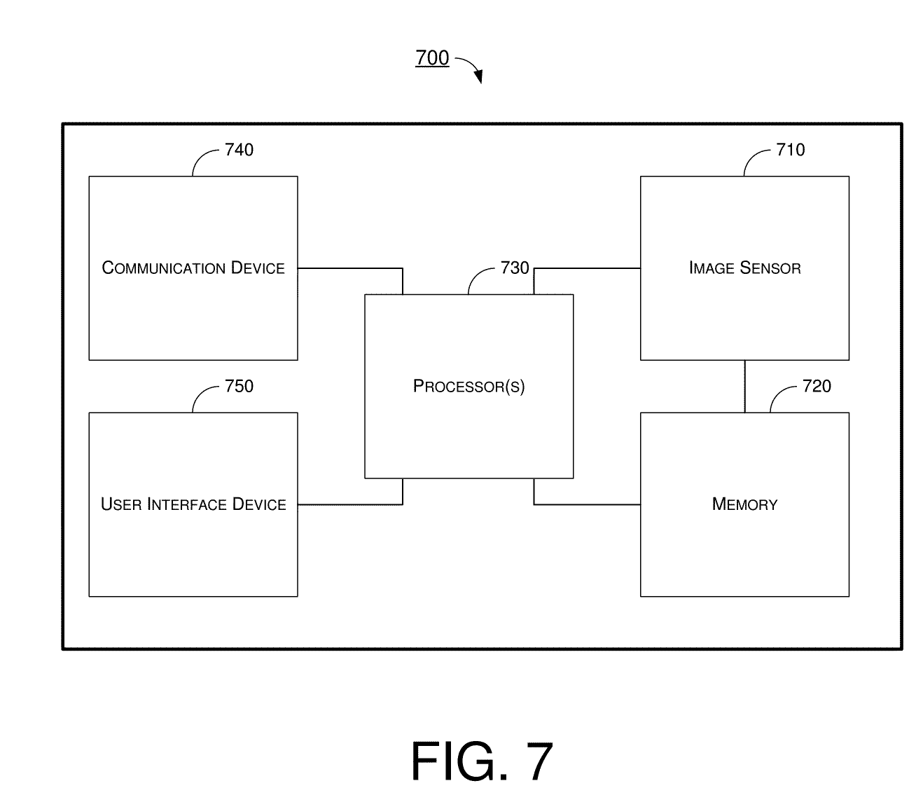

FIG. 7 illustrates an example apparatus 700 in accordance with an implementation of the present disclosure. Apparatus 700 may be an example implementation of apparatus 110 and/or apparatus 120. Apparatus 700 may perform various functions to implement techniques, methods and systems described herein, including scenario 100, scenario 200, feature 300, feature 400, feature 500 and feature 600 described above as well as process 800 and process 900 described below. In some implementations, apparatus 700 may be a portable electronic apparatus such as, for example, a smartphone, a wearable device or a computing device such as a tablet computer, a laptop computer, a notebook computer.

Apparatus 700 may include at least those components shown in FIG. 7. To avoid obscuring FIG. 7 and/or understanding of apparatus 700, certain components of apparatus 700 not relevant to implementations of the present disclosure are not shown in FIG. 7. Referring to FIG. 7, apparatus 700 may include an image sensor 710, a memory 720, one or more processors 730, a communication device 740 and a user interface device 750.

Image sensor 710 may be implemented by, for example and not limited to, an active pixel sensor such as, for example, a complementary metal-oxide-semiconductor (CMOS) sensor, a charge-coupled device (CCD) sensor or any image sensing device currently existing or to be developed in the future. Image sensor 710 may be configured to detect and convey information that constitutes an image, and may be utilized to capture, take or otherwise obtain still images and/or video images.

Memory 720 may be implemented by any suitable type of memory device currently existing or to be developed in the future, and may include, for example and not limited to, volatile memory such as random-access memory (RAM), non-volatile memory such as read-only memory (ROM) and non-volatile RAM, or any combination thereof. In the case of RAM, memory 720 may include, for example and not limited to, dynamic RAM (DRAM), static RAM (SRAM), thyristor RAM (T-RAM) and/or zero-capacitor RAM (Z-RAM). In the case of ROM, memory 720 may include, for example and not limited to, mask ROM, programmable ROM (PROM), erasable programmable ROM (EPROM) and/or electrically erasable programmable ROM (EEPROM). In the case of non-volatile RAM, memory 720 may include, for example and not limited to, flash memory, solid-state memory, magnetoresistive RAM (MRAM), non-volatile SRAM (nvSRAM), ferroelectric RAM (FeRAM) and/or phase-change memory (PRAM). Memory 720 may be communicatively coupled to image sensor 710 and configured to store still image(s) and/or video image(s) captured, taken or otherwise obtained by image sensor 710. Memory 720 may also be configured to store one or more sets of instructions which, when executed by one or more processors 730, render the one or more processors 730 to perform operations in accordance with various implementations of the present disclosure.

Communication device 740 may be implemented by, for example and not limited to, a single integrated-circuit (IC) chip, a chipset including one or more IC chips or any suitable electronics, and may include at least one antenna for wireless communication. Communication device 740 may be configured to transmit and receive data/information by wireless (and optionally wired) means. Communication device 740 may be configured to transmit and receive data/information in one or more modes including, for example and not limited to, radio frequency (RF) mode, free-space optical mode, sonic/acoustic mode and electromagnetic induction mode. For instance, communication device 740 may be configured to transmit and receive data/information via Wi-Fi in accordance with the Institute of Electrical and Electronics Engineers (IEEE) 802.11 standards. In the context of scenario 100, scenario 200, feature 300, feature 400, feature 500, feature 600, process 800 and process 900, communication device 740 may be configured to wirelessly receive data, information, command(s), still image(s) and/or video image(s) from one or more other apparatuses as well as to transmit data, information, command(s), still image(s) and/or video image(s) to one or more other apparatuses.

User interface device 750 may be implemented by, for example and not limited to, display panel, touch sensing display, voltage-sensing touch panel, capacitive-sensing touch panel, resistive-sensing touch panel, force-sensing touch panel, keyboard, keypad, trackball, joystick, microphone(s), speaker(s), or a combination thereof. User interface device 750 may be configured to provide or otherwise present data/information to a user of apparatus 700 as well as to receive data/information/command(s) from the user.

Processor(s) 730 may be implemented by, for example and not limited to, a single IC chip or a chipset including one or more IC chips. Processor(s) 730 may be communicatively coupled to each of image sensor 710, memory 720, communication device 740 and user interface device 750 to control the operations thereof, including receiving data/information therefrom and providing data/information/command(s) thereto. Processor(s) 730 may be configured to perform operations in accordance to various implementations of the present disclosure. For instance, processor(s) 730 may receive first data obtained at a first time by image sensor 710, and receive second data obtained at a second time by an image sensor of a different and remote apparatus. The second data may be wirelessly received from the remote apparatus by communication device 740 and provided to processor(s) 730 for processing. Processor(s) 730 may perform one or more tasks using at least the first data and the second data as input. In some implementations, the first data may include at least image or video related data, and the second data may include at least image or video related data. In some implementations, a location or position at which the second data is obtained may be different from a location or position at which the first data is obtained. In some implementations, the first time may be equal to or different from the second time by no more than a predetermined time difference (e.g., one or more thousandths of a second, one or more hundredths of a second, one or more tenths of a second, one or more seconds, or any suitable duration depending on the actual implementation). In some implementations, either or both of the first data and the second data may also include audio data. In some implementations, an orientation of the remote apparatus when the second data is obtained may be different from an orientation of apparatus 700 when the first data is obtained.

In some implementations, in performing the task, processor(s) 730 may generate composite data by combining or superposing the first data and the second data.

In some implementations, in performing the task, processor(s) 730 may render a picture-in-picture effect using a first picture represented by the first data and a second picture represented by the second data.

In some implementations, in performing the task, processor(s) 730 may generate one or more stereo features using at least the first data and the second data. In some implementations, the one or more stereo features may include a 3D visual effect. In some implementations, the 3D visual effect may include at least one of a depth map or a 3D capture. Alternatively or additionally, the one or more stereo features may include at least one of fast autofocus, image refocus, or distance measurement.

In some implementations, in performing the task, processor(s) 730 may perform at least one of the following: motion estimation, object detection, exposure synchronization, or color synchronization.

In some implementations, in performing the task, processor(s) 730 may generate third data based at least in part on the first data and the second data. Moreover, processor(s) 730 may wirelessly transmit, via communication device 740, the third data to another different and remote apparatus different from apparatus 700 and the remote apparatus.

In some implementations, in performing the task, processor(s) 730 may generate third data based at least in part on the first data and the second data. Moreover, processor(s) 730 may wirelessly transmit, via communication device 740, the third data to the remote apparatus to control one or more operations of the remote apparatus. In some implementations, in wirelessly transmitting the third data to the remote apparatus to control the one or more operations of the remote apparatus, processor(s) 730 may wirelessly transmit, via communication device 740, the third data to the remote apparatus to control sequential generation of the second data.

In some implementations, in performing the task, processor(s) 730 may determine whether either or both of the first data and the second data satisfies one or more criteria. Moreover, processor(s) 730 may perform one or more remedial actions in response to a determination that at least one of the first data and the second data does not satisfy the one or more criteria. In some implementations, in performing the one or more remedial actions, processor(s) 730 may generate third data based at least in part on the first data and the second data. Furthermore, processor(s) 730 may wirelessly transmit, via communication device 740, the third data to the remote apparatus to control one or more operations of the remote apparatus.

Alternatively or additionally, in performing the one or more remedial actions, processor(s) 730 may adjust one or more parameters associated with either or both of the first data and the second data. In some implementations, processor(s) 730 may also provide an indication (e.g., visual and/or audible indication(s)) to a user to request an input for the adjusting of the one or more parameters associated with either or both of the first data and the second data.

Alternatively or additionally, in performing the one or more remedial actions, processor(s) 730 may retrieve an image of a plurality of images that is previously received from the first image sensor or the second image sensor and satisfying the one or more criteria.

Alternatively or additionally, in performing the one or more remedial actions, processor(s) 730 may generate a signal to adjust at least one of a camera exposure, a focus, or a frame rate of each of either or both of the first image sensor or the second image sensor.

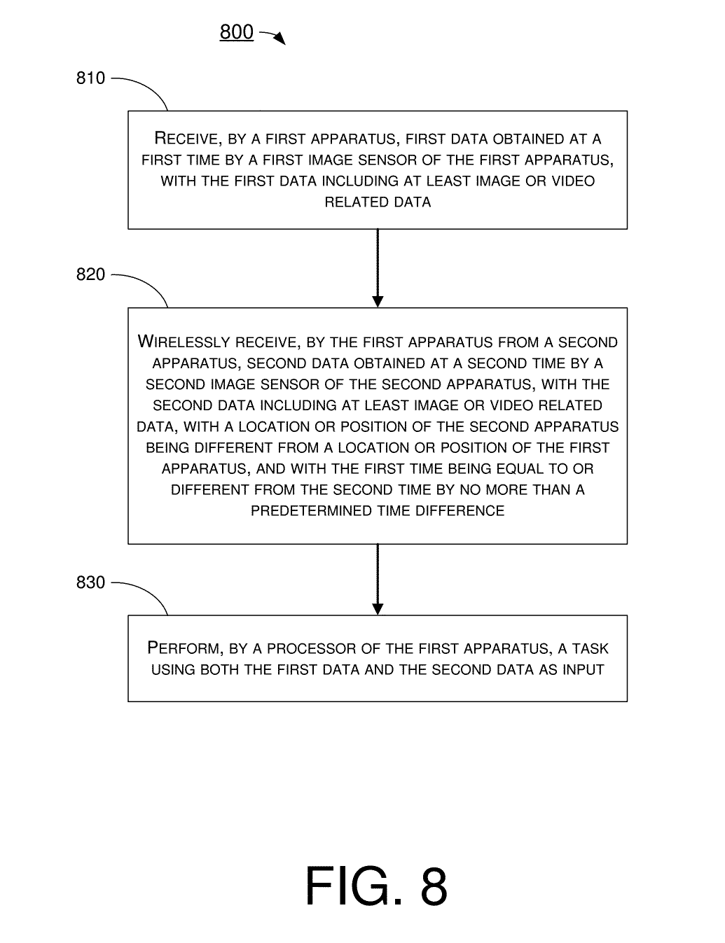

FIG. 8 illustrates an example process 800 in accordance with an implementation of the present disclosure. Process 800 may include one or more operations, actions, or functions as represented by one or more of blocks 810, 820 and 830. Although illustrated as discrete blocks, various blocks of process 800 may be divided into additional blocks, combined into fewer blocks, or eliminated, depending on the desired implementation. The blocks may be performed in the order shown in FIG. 8 or in any other order, depending on the desired implementation. Process 800 may be implemented by apparatus 110, apparatus 120 and apparatus 700. Solely for illustrative purpose and without limiting the scope of the present disclosure, process 800 is described below in the context of process 800 being performed by apparatus 110 and apparatus 120 in scenario 100 and/or scenario 200. Process 800 may begin at 810.

At 810, process 800 may involve apparatus 110 receiving first data obtained at a first time by a first image sensor of apparatus 110, with the first data including at least image or video related data. Process 800 may proceed from 810 to 820.

At 820, process 800 may involve apparatus 110 wirelessly receiving, from apparatus 120, second data obtained at a second time by a second image sensor of apparatus 120, with the second data including at least image or video related data. A location or position of apparatus 120 may be different from a location or position of apparatus 110. The first time may be equal to or different from the second time by no more than a predetermined time difference (e.g., half a second, one second or another suitable duration). Process 800 may proceed from 820 to 830.

At 830, process 800 may involve apparatus 110 performing a task using both the first data and the second data as input.

In some implementations, either or both of the first data and the second data may further include audio data.

In some implementations, an orientation of apparatus 120 may be different from an orientation of apparatus 110.

In some implementations, in performing the task, process 800 may involve apparatus 110 generating composite data by combining or superposing the first data and the second data. Alternatively or additionally, in performing the task, process 800 may involve apparatus 110 rendering a picture-in-picture effect using a first picture represented by the first data and a second picture represented by the second data (e.g., as in scenario 200). Alternatively or additionally, in performing the task, process 800 may involve apparatus 110 generating one or more stereo features using at least the first data and the second data (e.g., as in scenario 100). In some implementations, the one or more stereo features may include a 3D visual effect. In some implementations, the 3D visual effect may include at least one of a depth map or a 3D capture. In some implementations, the one or more stereo features may include at least one of fast autofocus, image refocus, or distance measurement.

In some implementations, apparatus 110 and apparatus 120 may include a first camera and a second camera, respectively. The first camera and the second camera may correspond to the first image sensor and the second image sensors, respectively. In some implementations, the task may include at least one of motion estimation, object detection, exposure synchronization, or color synchronization.

In some implementations, in performing the task, process 800 may involve apparatus 110 performing a number of operations. For instance, process 800 may involve apparatus 110 generating third data based at least in part on the first data and the second data. Process 800 may also involve apparatus 110 wirelessly transmitting the third data to a third apparatus different from apparatus 110 and apparatus 120.

In some implementations, in performing the task, process 800 may involve apparatus 110 performing a number of operations. For instance, process 800 may involve apparatus 110 generating third data based at least in part on the first data and the second data. Process 800 may also involve apparatus 110 wirelessly transmitting the third data to apparatus 120 to control one or more operations of apparatus 120. In some implementations, in wirelessly transmitting of the third data to apparatus 120 to control the one or more operations of apparatus 120, process 800 may involve apparatus 110 wirelessly transmitting the third data to apparatus 120 to control sequential generation of the second data.

In some implementations, process 800 may further involve either or both of apparatus 110 and apparatus 120 determining whether either or both of the first data and the second data satisfies one or more criteria. Process 800 may also involve either or both of apparatus 110 and apparatus 120 performing one or more remedial actions in response to a determination that at least one of the first data and the second data does not satisfy the one or more criteria. In some implementations, in performing the one or more remedial actions, process 800 may involve apparatus 110 generating third data based at least in part on the first data and the second data. Process 800 may also involve apparatus 110 wirelessly transmitting the third data to apparatus 120 to control one or more operations of apparatus 120. In some implementations, the determining and the performing may be executed by the same apparatus or different apparatuses of apparatus 110 and apparatus 120. In some implementations, in performing the one or more remedial actions, process 800 may involve apparatus 110 adjusting one or more parameters associated with either or both of the first data and the second data. Process 800 may further involve apparatus 110 providing an indication to a user to request an input for the adjusting of the one or more parameters associated with either or both of the first data and the second data.

In some implementations, in performing the one or more remedial actions, process 800 may involve apparatus 110 retrieving an image of a plurality of images that is previously received from the first image sensor or the second image sensor and satisfying the one or more criteria.

In some implementations, apparatus 110 and apparatus 120 may include a first camera and a second camera, respectively. The first camera and the second camera may correspond to the first image sensor and the second image sensor, respectively. In performing the one or more remedial actions, process 800 may involve apparatus 110 generating a signal to adjust at least one of a camera exposure, a focus, or a frame rate of each of either or both of the first image sensor or the second image sensor.

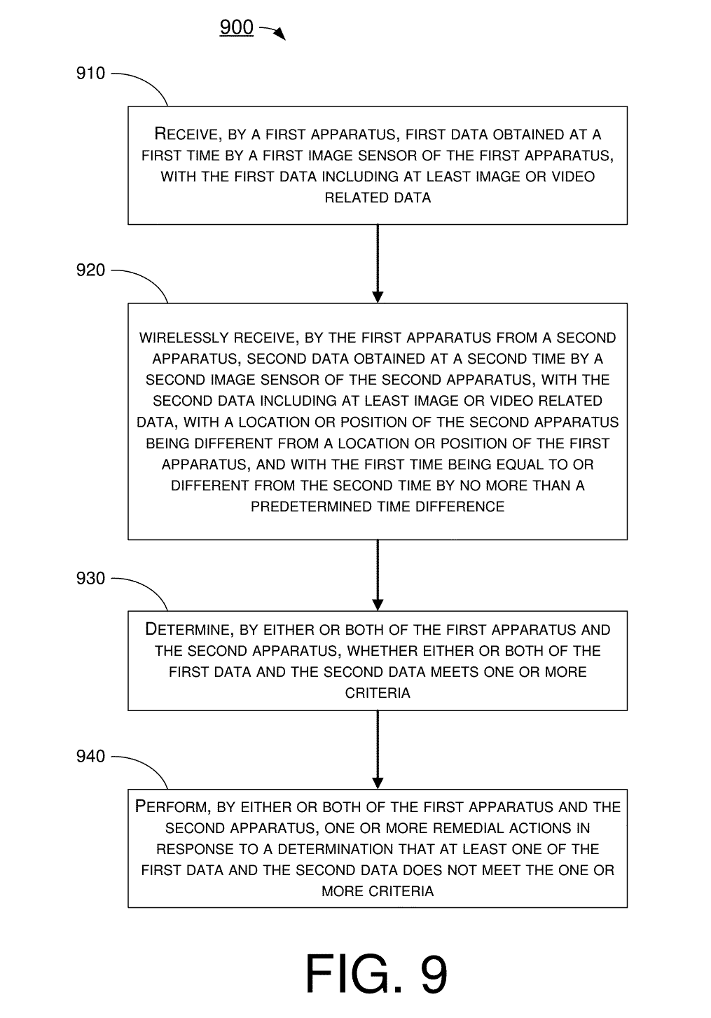

FIG. 9 illustrates an example process 900 in accordance with an implementation of the present disclosure. Process 900 may include one or more operations, actions, or functions as represented by one or more of blocks 910, 920, 930 and 940. Although illustrated as discrete blocks, various blocks of process 900 may be divided into additional blocks, combined into fewer blocks, or eliminated, depending on the desired implementation. The blocks may be performed in the order shown in FIG. 9 or in any other order, depending on the desired implementation. Process 900 may be implemented by apparatus 110, apparatus 120 and apparatus 700. Solely for illustrative purpose and without limiting the scope of the present disclosure, process 900 is described below in the context of process 900 being performed by apparatus 110 and apparatus 120 in scenario 100 and/or scenario 200. Process 900 may begin at 910.

At 910, process 900 may involve apparatus 110 receiving first data obtained at a first time by a first image sensor of apparatus 110, with the first data including at least image or video related data. Process 900 may proceed from 910 to 920.

At 920, process 900 may involve apparatus 110 wirelessly receiving, from apparatus 120, second data obtained at a second time by a second image sensor of apparatus 120, with the second data including at least image or video related data. A location or position of apparatus 120 may be different from a location or position of apparatus 110. The first time may be equal to or different from the second time by no more than a predetermined time difference. Process 900 may proceed from 920 to 930.

At 930, process 900 may involve either or both of apparatus 110 and apparatus 120 determining whether either or both of the first data and the second data satisfies one or more criteria. Process 900 may proceed from 930 to 940.

At 940, process 900 may involve either or both of apparatus 110 and apparatus 120 performing one or more remedial actions in response to a determination that at least one of the first data and the second data does not satisfy the one or more criteria.

In some implementations, in performing the one or more remedial actions, process 900 may involve either or both of apparatus 110 and apparatus 120 providing an indication to a user to request an adjustment of at least a parameter associated with apparatus 110 or apparatus 120. Alternatively or additionally, in performing the one or more remedial actions, process 900 may involve either or both of apparatus 110 and apparatus 120 retrieving an image of a plurality of images that is previously received from the second image sensor or the first image sensor and satisfying the one or more criteria. Alternatively or additionally, in performing the one or more remedial actions, process 900 may involve either or both of apparatus 110 and apparatus 120 generating a signal to adjust a camera exposure, a focus or a frame rate of the second image sensor or the first image sensor.

In some implementations, process 900 may further involve apparatus 110 performing a task using at least the first data and the second data as input in response to a determination that the first data and the second data satisfy the one or more criteria. In some implementations, either or both of the first data and the second data may include image or video related data, and a location or position at which the second data is obtained may be different from a location or position at which the first data is obtained. In some implementations, in performing the task, process 900 may further involve apparatus 110 rendering a picture-in-picture effect using a first picture represented by the first data and a second picture represented by the second data (e.g., scenario 200). In some implementations, in performing the task, process 900 may further involve apparatus 110 generating a 3D visual effect using at least the first data and the second data. In some implementations, the 3D visual effect may include at least one of a depth map or a 3D capture. Alternatively or additionally, in performing the task, process 900 may further involve apparatus 110 generating one or more stereo features using at least the first data and the second data. In some implementations, the one or more stereo features may include at least one of fast autofocus, image refocus, or distance measurement.

In some implementations, apparatus 110 and apparatus 120 may include a first camera and a second camera, respectively. The first camera and the second camera may correspond to the first image sensor and the second image sensors, respectively. The task may include motion estimation, object detection, exposure synchronization, or color synchronization.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a first apparatus, first data obtained at a first time by a first image sensor of the first apparatus, wherein the first data comprises at least image or video related data;
wirelessly receiving, by the first apparatus from a second apparatus, second data obtained at a second time by a second image sensor of the second apparatus, wherein the second data comprises at least image or video related data, wherein a location or position of the second apparatus is different from a location or position of the first apparatus, and wherein the first time is equal to or different from the second time by no more than a predetermined time difference; and
performing, by one or more processors of the first apparatus, a task using both the first data and the second data as input.

2. The method of claim 1, wherein either or both of the first data and the second data further comprise audio data.

3. The method of claim 1, wherein an orientation of the second apparatus is different from an orientation of the first apparatus.

4. The method of claim 1, wherein the performing of the task comprises generating composite data by combining or superposing the first data and the second data.

5. The method of claim 1, wherein the performing of the task comprises rendering a picture-in-picture effect using a first picture represented by the first data and a second picture represented by the second data.

6. The method of claim 1, wherein the performing of the task comprises generating one or more stereo features using at least the first data and the second data.

7. The method of claim 6, wherein the one or more stereo features comprises a three-dimensional (3D) visual effect.

8. The method of claim 7, wherein the 3D visual effect comprises at least one of a depth map or a 3D capture.

9. The method of claim 6, wherein the one or more stereo features comprise at least one of fast autofocus, image refocus, or distance measurement.

10. The method of claim 1, wherein the first apparatus and the second apparatus comprise a first camera and a second camera, respectively, the first camera and the second camera corresponding to the first image sensor and the second image sensors, respectively.

11. The method of claim 10, wherein the task comprises at least one of motion estimation, object detection, exposure synchronization, or color synchronization.

12. The method of claim 1, wherein the performing of the task comprises:
generating third data based at least in part on the first data and the second data; and
wirelessly transmitting the third data to a third apparatus different from the first apparatus and the second apparatus.

13. The method of claim 1, wherein the performing of the task comprises:
generating third data based at least in part on the first data and the second data; and
wirelessly transmitting the third data to the second apparatus to control one or more operations of the second apparatus.

14. The method of claim 13, wherein the wirelessly transmitting of the third data to the second apparatus to control the one or more operations of the second apparatus comprises wirelessly transmitting the third data to the second apparatus to control sequential generation of the second data.

15. The method of claim 1, further comprising:
determining, by either or both of the first apparatus and the second apparatus, whether either or both of the first data and the second data satisfies one or more criteria; and
performing, by either or both of the first apparatus and the second apparatus, one or more remedial actions in response to a determination that at least one of the first data and the second data does not satisfy the one or more criteria.

16. The method of claim 15, wherein the performing of the one or more remedial actions comprises:
generating, by the first apparatus, third data based at least in part on the first data and the second data; and
wirelessly transmitting, by the first apparatus, the third data to the second apparatus to control one or more operations of the second apparatus.

17. The method of claim 15, wherein the determining and the performing are executed by a same apparatus or different apparatuses of the first apparatus and the second apparatus.

18. The method of claim 15, wherein the performing of the one or more remedial actions comprises adjusting one or more parameters associated with either or both of the first data and the second data.

19. The method of claim 18, further comprising:
providing an indication to a user to request an input for the adjusting of the one or more parameters associated with either or both of the first data and the second data.

20. The method of claim 15, wherein the performing of the one or more remedial actions comprises retrieving an image of a plurality of images that is previously received from the first image sensor or the second image sensor and satisfying the one or more criteria.

21. The method of claim 15, wherein the first apparatus and the second apparatus comprise a first camera and a second camera, respectively, the first camera and the second camera corresponding to the first image sensor and the second image sensor, respectively, and wherein the performing of the one or more remedial actions comprises generating a signal to adjust at least one of a camera exposure, a focus, or a frame rate of each of either or both of the first image sensor or the second image sensor.

22. A method, comprising:
receiving, by a first apparatus, first data obtained at a first time by a first image sensor of the first apparatus, wherein the first data comprises at least image or video related data;
wirelessly receiving, by the first apparatus from a second apparatus, second data obtained at a second time by a second image sensor of the second apparatus, wherein the second data comprises at least image or video related data, wherein a location or position of the second apparatus is different from a location or position of the first apparatus, and wherein the first time is equal to or different from the second time by no more than a predetermined time difference;
determining, by either or both of the first apparatus and the second apparatus, whether either or both of the first data and the second data satisfies one or more criteria; and
performing, by either or both of the first apparatus and the second apparatus, one or more remedial actions in response to a determination that at least one of the first data and the second data does not satisfy the one or more criteria.

23. The method of claim 22, wherein the performing of the one or more remedial actions comprises providing an indication to a user to request an adjustment of at least a parameter associated with the first apparatus or the second apparatus.

24. The method of claim 22, wherein the performing of the one or more remedial actions comprises retrieving an image of a plurality of images that is previously received from the second image sensor or the first image sensor and satisfying the one or more criteria.

25. The method of claim 22, wherein the performing of the one or more remedial actions comprises generating a signal to adjust a camera exposure, a focus or a frame rate of the second image sensor or the first image sensor.

26. The method of claim 22, further comprising:
performing a task using at least the first data and the second data as input in response to a determination that the first data and the second data satisfy the one or more criteria.

27. The method of claim 24, wherein either or both of the first data and the second data comprise image or video related data, and wherein a location or position at which the second data is obtained is different from a location or position at which the first data is obtained.

28. The method of claim 26, wherein the performing of the task comprises rendering a picture-in-picture effect using a first picture represented by the first data and a second picture represented by the second data.

29. The method of claim 26, wherein the performing of the task comprises generating a three-dimensional (3D) visual effect using at least the first data and the second data.

30. The method of claim 29, wherein the 3D visual effect comprises at least one of a depth map or a 3D capture.

31. The method of claim 26, wherein the performing of the task comprises generating one or more stereo features using at least the first data and the second data.

32. The method of claim 31, wherein the one or more stereo features comprise at least one of fast autofocus, image refocus, or distance measurement.

33. The method of claim 22, wherein the first apparatus and the second apparatus comprise a first camera and a second camera, respectively, the first camera and the second camera corresponding to the first image sensor and the second image sensors, respectively, and wherein the task comprises motion estimation, object detection, exposure synchronization, or color synchronization.

34. A first apparatus, comprising:
a first image sensor;
a memory configured to store at least data or one or more sets of instructions therein; and
one or more processors coupled to access the data or the one or more sets of instructions stored in the memory, the one or more processors configured to perform operations comprising:
receiving second data obtained at a second time by a second image sensor of a second apparatus, the second data transmitted wirelessly by the second apparatus;
receiving first data obtained at a first time by the first image sensor; and
performing a task using at least the second data and the first data as input,
wherein the first data comprises at least image or video related data,
wherein the second data comprises at least image or video related data,
wherein a location or position at which the second data is obtained is different from a location or position at which the first data is obtained, and
wherein the first time is equal to or different from the second time by no more than a predetermined time difference.

35. The first apparatus of claim 34, wherein either or both of the first data and the second data further comprise audio data.

36. The first apparatus of claim 34, wherein an orientation of the second apparatus when the second data is obtained is different from an orientation of the first apparatus when the first data is obtained.

37. The first apparatus of claim 34, wherein, in performing the task, the one or more processors is configured to generate composite data by combining or superposing the first data and the second data.

38. The first apparatus of claim 34, wherein, in performing the task, the one or more processors is configured to render a picture-in-picture effect using a first picture represented by the first data and a second picture represented by the second data.

39. The first apparatus of claim 34, wherein, in performing the task, the one or more processors is configured to generate one or more stereo features using at least the first data and the second data.

40. The first apparatus of claim 39, wherein the one or more stereo features comprises a three-dimensional (3D) visual effect.

41. The first apparatus of claim 40, wherein the 3D visual effect comprises at least one of a depth map or a 3D capture.

42. The first apparatus of claim 39, wherein the one or more stereo features comprise at least one of fast autofocus, image refocus, or distance measurement.

43. The first apparatus of claim 34, wherein, in performing the task, the one or more processors is configured to perform at least one of motion estimation, object detection, exposure synchronization, or color synchronization.

44. The first apparatus of claim 34, wherein, in performing the task, the one or more processors is configured to perform operations comprising:
generating third data based at least in part on the first data and the second data; and
wirelessly transmitting the third data to a third apparatus different from the first apparatus and the second apparatus.

45. The first apparatus of claim 34, wherein, in performing the task, the one or more processors is configured to perform operations comprising:
generating third data based at least in part on the first data and the second data; and
wirelessly transmitting the third data to the second apparatus to control one or more operations of the second apparatus.

46. The first apparatus of claim 45, wherein, in wirelessly transmitting the third data to the second apparatus to control the one or more operations of the second apparatus, the one or more processors is configured to wirelessly transmit the third data to the second apparatus to control sequential generation of the second data.

47. The first apparatus of claim 34, wherein the one or more processors is further configured to perform operations comprising:
determining whether either or both of the first data and the second data satisfies one or more criteria; and
performing one or more remedial actions in response to a determination that at least one of the first data and the second data does not satisfy the one or more criteria.

48. The first apparatus of claim 47, wherein, in performing the one or more remedial actions, the one or more processors is configured to perform operations comprising:
generating third data based at least in part on the first data and the second data; and
wirelessly transmitting the third data to the second apparatus to control one or more operations of the second apparatus.

49. The first apparatus of claim 47, wherein, in performing the one or more remedial actions, the one or more processors is configured to adjust one or more parameters associated with either or both of the first data and the second data.

50. The first apparatus of claim 49, wherein the one or more processors is further configured to perform operations comprising:
providing an indication to a user to request an input for the adjusting of the one or more parameters associated with either or both of the first data and the second data.

51. The first apparatus of claim 47, wherein, in performing the one or more remedial actions, the one or more processors is configured to retrieve an image of a plurality of images that is previously received from the first image sensor or the second image sensor and satisfying the one or more criteria.

52. The first apparatus of claim 47, wherein, in performing the one or more remedial actions, the one or more processors is configured to generate a signal to adjust at least one of a camera exposure, a focus, or a frame rate of each of either or both of the first image sensor or the second image sensor.
